(19) United States
(12) Patent Application Publication
(10) Pub. No.: US 2024/0011801 A1
(43) Pub. Date: Jan. 11, 2024

(54) CAPACITIVE SENSOR

(71) Applicant: ALPS ALPINE CO., LTD., Tokyo (JP)

(72) Inventors: Tatsumi FUJIYOSHI, Miyagi-ken (JP); Tetsuya SUZUKI, Niigata-ken (JP); Shinichi HIGUCHI, Fukushima-ken (JP); Yoshinao TANIGUCHI, Miyagi-ken (JP)

(73) Assignee: ALPS ALPINE CO., LTD., Tokyo (JP)

(21) Appl. No.: 18/472,567

(22) Filed: Sep. 22, 2023

Related U.S. Application Data
(63) Continuation of application No. PCT/JP2022/000584, filed on Jan. 11, 2022.

(30) Foreign Application Priority Data
Mar. 23, 2021 (JP) 2021-048247

(51) Int. Cl. G01D 5/24; G06F 3/041; G06F 3/044

(52) U.S. Cl. CPC G01D 5/2405; G06F 3/04166; G06F 3/044; G06F 2203/04107; G06F 2203/04108

(57) ABSTRACT

A capacitive sensor has: one or more front-side electrodes including at least one detection electrode; an elastic dielectric body disposed below the front-side electrodes; a shield electrode disposed below the elastic dielectric body; a first, second, and third voltage output unit that respectively outputs a first, second, and third AC voltage; and a detection unit that detects a proximity, a contact, and pressing of a detection target to the detection electrode. The first, second, and third AC voltages have substantially the same frequency. The amplitude of the first AC voltage is larger than or equal to the amplitude of the second AC voltage. The amplitude of the third AC voltage is smaller than the amplitude of the second AC voltage. The first AC voltage is output to a driving unit coupled to the detection electrode with capacitances intervening between them. The second AC voltage is applied to the detection electrode.

### CLAIM OF PRIORITY

This application is a Continuation of International Application No. PCT/JP2022/000584 filed on Jan. 11, 2022, which claims benefit of Japanese Patent Application No. 2021-048247 filed on Mar. 23, 2021. The entire contents of each application noted above are hereby incorporated by reference.

### BACKGROUND OF THE INVENTION

### 1. Field of the Invention

The present invention relates to a capacitive sensor.

### 2. Description of the Related Art

A conventional proximity/contact sensor has: a first detection means that includes a sheet-like upper electrode layer having a plurality of upper electrodes that pass electricity in one direction, and also includes a sheet-like lower electrode layer having a plurality of lower electrodes insulated from the upper electrodes, the lower electrodes passing electricity in a direction different from the direction in which upper electrodes pass electricity, the lower electrodes being placed so as to intersect the upper electrodes; an intermediate layer placed below the first detection means, the intermediate layer deforming according to a contact or pressure of a target; a second detection means placed below the intermediate layer, the second detection means detecting an electrical change according to the contact or pressing force of the target; a computation means that makes, when the target comes close to the first detection means, a decision about a proximity of the target according to an electrical change between the upper electrode and the lower electrode, and identifies, when the target adds a contact or a pressing force to the first detection means, the position at which the contact or pressing force of the target is added and the value of the pressing force according to the electrical change detected by the second detection means; and a switching means that switches a circuit at a predetermined interval so that any one of the first detection means and second detection means is connected to ground (see International Publication No. WO2014-080924, for example).

The conventional proximity/contact sensor needs to switch a circuit with the switching means to detect a proximity or a contact. This leads to complex detection processing.

In view of this, the present invention provides a capacitive sensor that can easily detect a proximity, a contact, and pressing of a detection target.

### SUMMARY OF THE INVENTION

A capacitive sensor in an embodiment of the present invention has: one or a plurality of front-side electrodes including one or more detection electrodes; an elastic dielectric body disposed below the one or plurality of front-side electrodes; a shield electrode disposed with the elastic dielectric body interposed between the shield electrode and the one or plurality of front-side electrodes; a first voltage output unit that outputs a first alternating-current voltage to a driving unit coupled to the one or more detection electrodes with capacitances intervening between the driving unit and the one or more detection electrodes; a second voltage output unit that outputs a second alternating-current voltage having a frequency substantially equal to the frequency of the first alternating-current voltage, the second alternating-current voltage being applied to the one or more detection electrodes; a third voltage output unit that outputs a third alternating-current voltage to the shield electrode, the third alternating-current voltage having a frequency substantially equal to the frequency of the first alternating-current voltage and to the frequency of the second alternating-current voltage; and a detection unit that detects a proximity, a contact, and pressing of a detection target to the one or more detection electrodes. The first voltage output unit, the second voltage output unit, and the third voltage output unit respectively output the first alternating-current voltage, the second alternating-current voltage, and the third alternating-current voltage so that the amplitude of the first alternating-current voltage becomes larger than or equal to the amplitude of the second alternating-current voltage and that the amplitude of the third alternating-current voltage becomes smaller than the amplitude of the second alternating-current voltage.

It is possible to provide a capacitive sensor that can easily detect a proximity, a contact, and pressing of a detection target.

### BRIEF DESCRIPTION OF THE DRAWINGS

FIG. 1 illustrates the planar structure of a capacitive sensor in embodiment 1;

FIG. 2 illustrates the sectional structure of part of the capacitive sensor;

FIG. 3 illustrates an equivalent circuit of the capacitive sensor;

FIG. 4 illustrates an example of the waveforms of a first alternating-current voltage, a second alternating-current voltage, and a third alternating-current voltage;

FIG. 5 illustrates a capacitive sensor in embodiment 2; and

FIG. 6 illustrates a capacitive sensor in embodiment 3.

### DESCRIPTION OF THE PREFERRED EMBODIMENTS

Embodiments to which a capacitive sensor in the present invention is applied will be described below.

### Embodiment 1

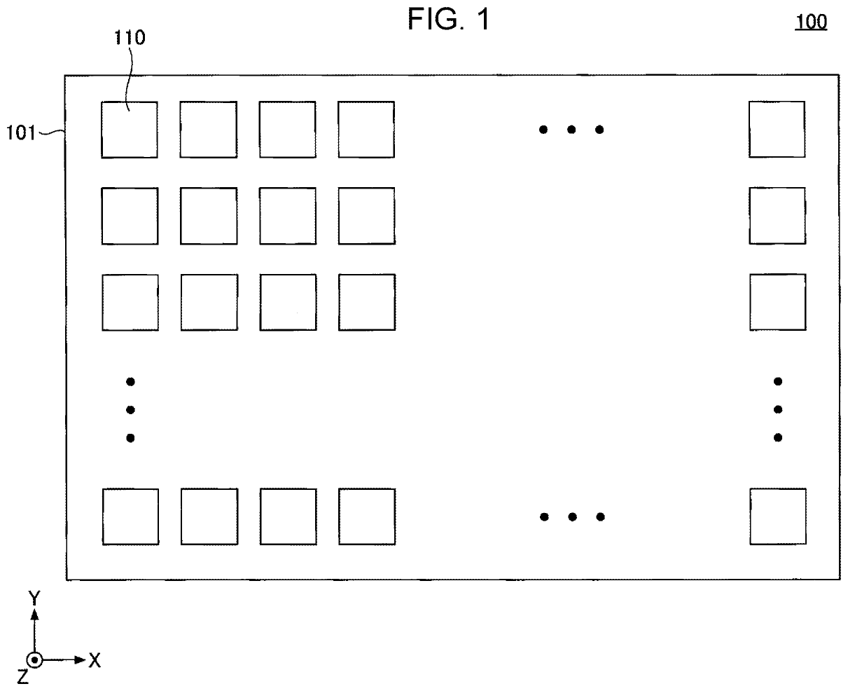

FIG. 1 illustrates the planar structure of a capacitive sensor 100 in embodiment 1. The description below is based on an XYZ coordinate system. A direction (X direction) parallel to the X axis, a direction (Y direction) parallel to the Y axis, and a direction (Z direction) parallel to the Z axis are mutually orthogonal. In the description below, the −Z-direction side may be referred to as the lower side or bottom, and the +Z-direction side may be referred to as the upper side or top, for convenience of explanation. However, these directions do not represent a universal up-down relationship. The phrase “in plan view” will refer to an XY plane being viewed. In the description below, for easy understanding of the structure, the length, bulkiness, thickness, and the like of each portion may be indicated by being exaggerated.

The capacitive sensor 100 includes a top panel 101 and a plurality of front-side electrodes 110. Besides them, the capacitive sensor 100 includes a detection unit and the like, the detection unit detecting a proximity, a contact, and pressing of a fingertip of the user or the like to the top panel 101. In FIG. 1, however, they are omitted and the planner structure of only the top panel 101 and the plurality of front-side electrodes 110 is illustrated.

As an example, the top panel 101 is a plate-like member that is made of transparent glass or a resin and has a rectangular shape in plan view, the member being capable of warping when the upper surface of the top panel 101 is pressed from above, the upper surface being a manipulation surface on which the user performs a manipulation input by touching the upper surface with a fingertip or the like. The user can also press the upper surface of the top panel 101 downward.

The plurality of front-side electrodes 110 are placed below the lower surface of the top panel 101 and are arranged in a matrix in the X direction and Y direction. The plurality of front-side electrodes 110 are mutually independent as an example, and are connected to a detection unit, which will be described later, and the like through wires, which are not illustrated, routed among them in plan view.

In FIG. 1, the plurality of front-side electrodes 110 are transparently illustrated. The plurality of front-side electrodes 110 are composed of transparent electrodes such as, for example, an indium tin oxide (ITO) material. An aspect will be described here in which the top panel 101 and the plurality of front-side electrodes 110 are transparent, assuming that a display panel, such as a liquid crystal display or an organic electroluminescence (EL) display, is placed below the capacitive sensor 100. However, if a display is not placed, for example, the top panel 101 and the plurality of front-side electrodes 110 may not be transparent and only need to be made of a conductive material. In this case, the plurality of front-side electrodes 110 may be metal plates or the like.

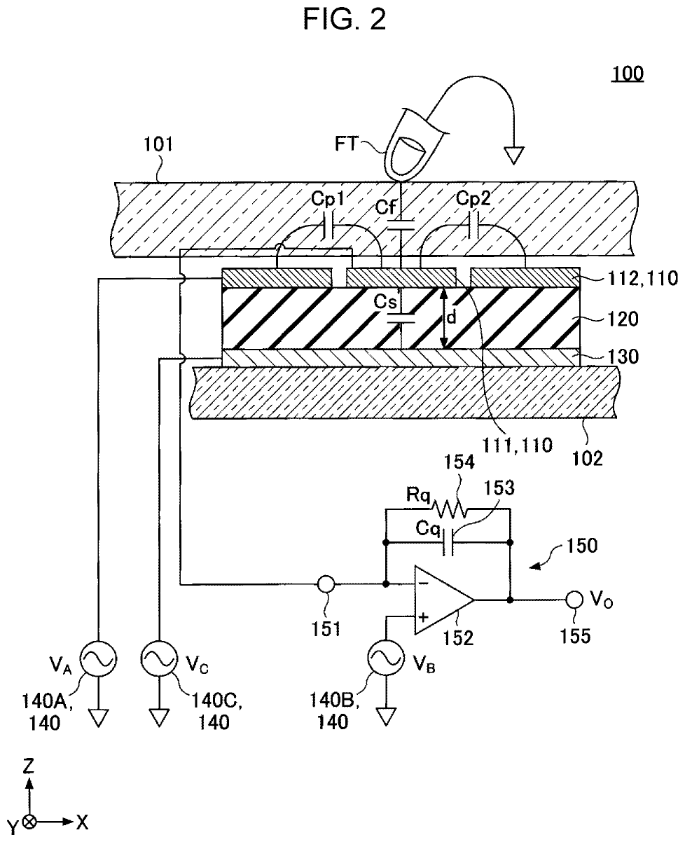

FIG. 2 illustrates the sectional structure of part of the capacitive sensor 100. Specifically, FIG. 2 illustrates the sectional structure of a portion at which three front-side electrodes 110 are arranged in the X direction. An aspect will be described here as an example in which the user performs a manipulation input on the capacitive sensor 100 with a fingertip FT. The user performs a manipulation input by touching (making contact with) the top panel 101 with the fingertip FT. In FIG. 2, each inverted triangle indicates ground.

Besides the top panel 101 and front-side electrodes 110, the capacitive sensor 100 further includes an elastic dielectric body 120, a shield electrode 130, a first voltage output unit 140A, a second voltage output unit 140B, a third voltage output unit 140C, and a detection unit 150. The capacitive sensor 100 further includes a substrate 102.

Of the three front-side electrodes 110 illustrated in FIG. 2, the front-side electrode 110 at the center is a detection electrode 111 and the remaining two front-side electrodes 110 on both sides of the detection electrode 111 are driving electrodes 112. The driving electrode 112 is an example of a driving unit. Therefore, the reference numeral 110 is indicated in parentheses for the detection electrode 111 and driving electrode 112. In the description below, the front-side electrode 110 will be referred to when the detection electrode 111 and driving electrode 112 are not particularly distinguished from each other and when a front-side electrode 110 other than the detection electrode 111 and driving electrode 112 is referred to.

The detection electrode 111 detects a proximity, a contact, and pressing of the fingertip FT of the user to the top panel 101. The capacitive sensor 100 detects a proximity, a contact, and pressing of the fingertip FT by sequentially selecting the plurality of front-side electrodes 110 one at a time as the detection electrode 111 and then detecting a capacitance. At this time, the second alternating-current voltage V_{B} is applied from the second voltage output unit 140B through the detection unit 150 to the detection electrode 111. When a contact or pressing is detected by the selected detection electrode 111, this indicates that a manipulation input has been performed at the position (coordinates) corresponding to that detection electrode 111.

Although an aspect will be described here in which the plurality of front-side electrodes 110 are sequentially selected one at a time as the detection electrode 111, two or more front-side electrodes 110 that are not adjacent to each other may be concurrently selected as detection electrodes 111 to concurrently perform detection of a proximity, a contact, and pressing of the fingertip FT at two or more detection electrodes 111. To do this, the plurality of front-side electrodes 110 include one or more detection electrodes 111.

The driving electrodes 112 are front-side electrodes 110 positioned on both sides of the detection electrode 111 in the X direction. When the capacitive sensor 100 sequentially selects the plurality of front-side electrodes 110 one at a time as the detection electrode 111, the capacitive sensor 100 selects two front-side electrodes 110 positioned on both sides of the detection electrode 111 in the X direction as two driving electrodes 112.

When a proximity, a contact, and pressing of the fingertip FT are to be detected with the detection electrode 111, the first alternating-current voltage V_{A} is applied from the first voltage output unit 140A to the driving electrodes 112. The first alternating-current voltage V_{A} has an amplitude V_{A} (V). Although an aspect will be described here in which two front-side electrodes 110 positioned on both sides of the detection electrode 111 in the X direction are used as the driving electrodes 112, a total of four front-side electrodes 110 composed of two front-side electrodes 110 positioned on both sides of the detection electrode 111 in the X direction and two front-side electrodes 110 positioned on both sides of the detection electrode 111 in the Y direction may be used as driving electrodes 112.

When the front-side electrode 110 positioned at an end of the −X direction, for example, is used as the detection electrode 111, two front-side electrodes 110 positioned on both sides of the detection electrode 111 in the Y direction may be used as the two driving electrodes 112. Alternatively, the front-side electrode 110 on the side of the detection electrode 111 in the +X direction and the front-side electrode 110 on the side of the detection electrode 111 in the −Y direction or +Y direction may be used as the two driving electrodes 112. When the front-side electrode 110 positioned at a corner of the plurality of front-side electrodes 110 arranged in a matrix is used as the detection electrode 111, it suffices to use the front-side electrode 110 on the side of the detection electrode 111 in the X direction and the front-side electrode 110 on the side of the detection electrode 111 in the Y direction as two driving electrodes 112.

The elastic dielectric body 120 is disposed below a plurality of front-side electrodes 110 (see FIGS. 1 and 2). The elastic dielectric body 120 is transparent. It can be elastically deformed. The elastic dielectric body 120 is formed from, for example, a urethane resin. The elastic dielectric body 120 is disposed at a position at which it overlaps all of the plurality of front-side electrodes 110 in plan view. The thickness of the elastic dielectric body 120 in the Z direction is uniform. Since the elastic dielectric body 120 can be elastically deformed, when the user presses a portion immediately above the detection electrode 111 in the downward direction, the portion being part of the upper surface of the top panel 101, with the fingertip FT, the elastic dielectric body 120 warps and contracts, so the detection electrode 111 is slightly displaced downward.

The shield electrode 130 is disposed on the upper surface of the substrate 102 and below the elastic dielectric body 120. That is, the shield electrode 130 is disposed with the elastic dielectric body 120 interposed between the shield electrode 130 and a plurality of front-side electrodes 110. The shield electrode 130 is provided to shield the plurality of front-side electrodes 110 from noise and to suppress a parasitic capacitance between the plurality of front-side electrodes 110 and ground. The third alternating-current voltage V_{C} output from the third voltage output unit 140C is applied to the shield electrode 130. The shield electrode 130 is formed from a transparent conductive material such as an ITO film, as an example. The substrate 102 is a transparent substrate that holds the shield electrode 130. When a display panel is not placed below the substrate 102, for example, the shield electrode 130 and the substrate 102 that holds the shield electrode 130 may not be transparent.

The first voltage output unit 140A outputs the first alternating-current voltage V_{A} to the driving electrode 112. The first voltage output unit 140A is structured so as to be connectable to all of the plurality of front-side electrodes 110, as an example. The first voltage output unit 140A is connected to two front-side electrodes 110 selected as the driving electrodes 112 by switching among the connections of wires to all of the plurality of front-side electrodes 110, and outputs the first alternating-current voltage V_{A}. to the selected two front-side electrodes 110. As described above, two or more front-side electrodes 110 that are not mutually adjacent may be concurrently selected as the detection electrodes 111 to concurrently perform detection of a proximity, a contact, and pressing of the fingertip FT. To do this, the first voltage output unit 140A outputs the first alternating-current voltage V_{A} to the driving electrodes 112, which are coupled to one or more detection electrodes 111 with capacitances intervening between the driving electrodes 112 and the detection electrodes 111.

The detection unit 150 preferably has an operational amplifier circuit (op-amp) 152 that has an inverting input terminal (−) connected to one or more detection electrodes 111 and also has a non-inverting input terminal (+) to which the second alternating-current voltage V_{B} is applied. The second voltage output unit 140B is connected to the non-inverting input terminal (+) of the op-amp 152 in the detection unit 150, and outputs the second alternating-current voltage V_{B} to the non-inverting input terminal (+). The second alternating-current voltage V_{B}, which has an amplitude of V_{B}, is equal to or lower than the first alternating-current voltage V_{A} (V_{A}≥V_{B}). The frequency of the second alternating-current voltage V_{B} is equal to the frequency of the first alternating-current voltage V_{A}.

The inverting input terminal (−) of the op-amp 152 is connected to the detection electrode 111 through an input terminal 151 of the detection unit 150. A capacitor 153 is connected between the inverting input terminal (−) of the op-amp 152 and its output terminal. The capacitance (electrostatic capacity) of the capacitor 153 is Cq. A resistor 154 is connected in parallel to the capacitor 153. The resistance of the resistor 154 is Rq. An output terminal 155 is connected to the output terminal of the op-amp 152. An output voltage at the output terminal 155 is V₀. A negative feedback operation is performed by the capacitor 153 and resistor 154, which are feedback elements. In the op-amp 152, therefore, due to a virtual short-circuit, the voltage at the inverting input terminal (−) becomes equal to a voltage to be applied to the non-inverting input terminal (+). Therefore, the second alternating-current voltage V_{B} is applied to the detection electrode 111. That is, the second voltage output unit 140B preferably outputs the second alternating-current voltage V_{B} to be applied to the front-side electrode 110 selected as the detection electrode 111.

The input terminal 151 of the detection unit 150 is structured so as to be connectable to all of the plurality of front-side electrodes 110, as an example. The input terminal 151 is connected to the front-side electrode 110 selected as the detection electrode 111 by switching among connections of wires to all of the plurality of front-side electrodes 110, and outputs the second alternating-current voltage V_{B} to the selected front-side electrode 110.

The third voltage output unit 140C is connected to the shield electrode 130, and outputs the third alternating-current voltage V_{C}. The amplitude V_{C} of the third alternating-current voltage V_{C} is smaller than the amplitude V_{B} of the second alternating-current voltage V_{B} (V_{B}>V_{C}). The third alternating-current voltage V_{C} has a frequency equal to the frequency of the first alternating-current voltage V_{A} and second alternating current V_{B}. The third alternating-current voltage V_{C} has an amplitude of V_{C}.

The detection unit 150 has the input terminal 151, op-amp 152, capacitor 153, resistor 154, and output terminal 155. The detection unit 150 detects a proximity, a contact, and pressing of the fingertip FT of the user by using the detection electrode 111.

As described above, the input terminal 151 is structured so as to be connectable to all of the plurality of front-side electrodes 110 as an example, and is connected to the selected detection electrode 111 by switching among wires.

The op-amp 152 has the inverting input terminal (−) connected to the detection electrode 111 through the input terminal 151 of the detection unit 150, and also has the non-inverting input terminal (+) that is connected to the second voltage output unit 140B and to which the second alternating-current voltage V_{B} is input. Since a negative feedback operation is performed by the capacitor 153 and resistor 154, which are feedback elements, the op-amp 152 performs an amplification operation so that the difference between the voltage at the inverting input terminal (−) and the voltage at the non-inverting input terminal (+) becomes zero. Therefore, due to a virtual short-circuit in the op-amp 152, which is used as a non-inverting amplifier circuit, the voltage at the inverting input terminal (−) becomes equal to a voltage to be applied to the non-inverting input terminal (+). Therefore, the second alternating-current voltage V_{B} is applied to the detection electrode 111.

The plurality of front-side electrodes 110 are arranged at equal intervals in the X direction and Y direction. A capacitance (electrostatic capacity) is present between adjacent front-side electrodes 110. That is, the detection electrode 111 and driving electrode 112 are coupled together with a capacitance intervening between them. In other words, the driving electrode 112 is coupled to the detection electrode 111 with a capacitance intervening between them. A capacitance between the detection electrode 111 and the driving electrode 112 on the −X-direction side will be denoted Cp1, and a capacitance between the detection electrode 111 and the driving electrode 112 on the +X-direction side will be denoted Cp2.

A capacitance (electrostatic capacity) generated between the detection electrode 111 and the fingertip FT will be denoted Cf. The capacitance Cf becomes larger as the fingertip FT comes closer to the detection electrode 111. Since the top panel 101 is present between the detection electrode 111 and the fingertip FT, the capacitance Cf is maximized when the fingertip FT is in contact with a portion, on the upper surface of the top panel 101, immediately above the detection electrode 111. Even when a pressing manipulation to press the top panel 101 downward is performed with the fingertip FT, the capacitance Cf remains substantially the same.

A capacitance (electrostatic capacity) between the detection electrode 111 and the shield electrode 130 will be denoted Cs. When the user presses a portion, on the upper surface of the top panel 101, immediately above the detection electrode 111, in the downward direction with the fingertip FT, the elastic dielectric body 120 warps and contracts, by which the distance d between the detection electrode 111 and the shield electrode 130 is shortened. Thus, when a pressing manipulation is performed, the capacitance Cs increases according the distance d between the detection electrode 111 and the shield electrode 130.

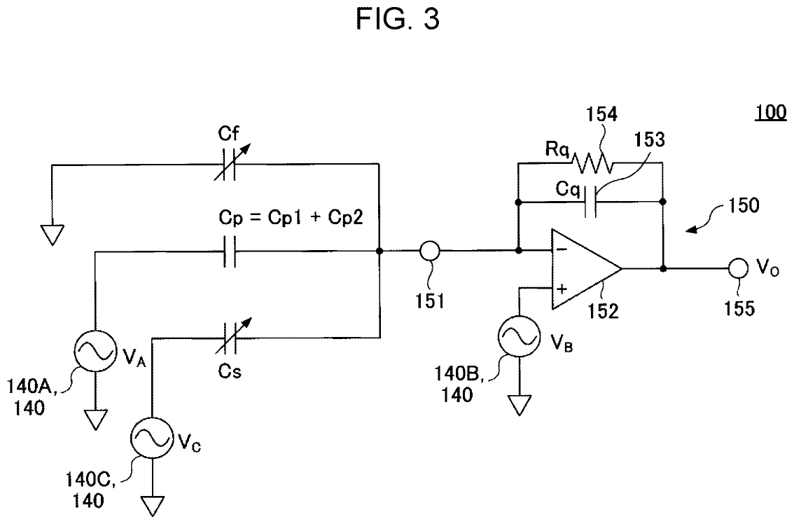

FIG. 3 illustrates an equivalent circuit of the capacitive sensor 100. Since the capacitance Cf changes according to the distance between the fingertip FT and the detection electrode 111, the capacitance Cf is illustrated as a variable capacitance. Similarly, since the capacitance Cs changes according to the distance d between the detection electrode 111 and the shield electrode 130, the capacitance Cs is illustrated as a variable capacitance.

In the capacitive sensor 100 having this type of structure, equation (1) below preferably holds. Equation (1) holds among the detection electrode 111, driving electrode 112, and shield electrode 130 according to the law of conservation of electric charge, and means that a voltage obtained by integration with the capacitor 153 having the capacitance Cq is the output voltage V₀. The capacitance Cp is Cp1+Cp2. When four driving electrodes 112 are used, the capacitance Cp is the total value of four capacitances generated among the detection electrode 111 and the four driving electrodes 112.

C_{f}×V_{B}+(V_{B}−V_{A})×Cₚ+(V_{B}−V_{C})×Cₛ=C_{q}×V_{O} (1)

When equation (1) is rewritten, the output voltage V₀ from the output terminal 155 is represented as in equation (2) below.

$$\frac{{C}_{f} \times {V}_{B} + ( {V}_{B} - {V}_{A} ) \times {C}_{p} + ( {V}_{B} - {V}_{C} ) \times {C}_{s}}{{C}_{q}} = {V}_{0} \qquad ( 2 )$$

The capacitance Cs between the detection electrode 111 and the shield electrode 130 is substantially represented as in equation (3) below. In equation (3), ε0 is a dielectric constant in a vacuum, εr is the specific inductive capacity of the elastic dielectric body 120, s is the area of the detection electrode 111, and d is the distance (gap) between the detection electrode 111 and the shield electrode 130. When the distance d is reduced, the capacitance Cf increases.

$${C}_{s} = {ε}_{0} {ε}_{r} \frac{s}{d} \qquad ( 3 )$$

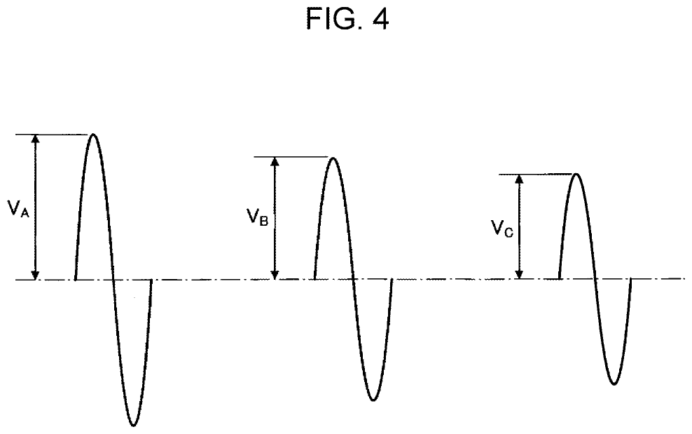

FIG. 4 illustrates an example of the waveforms of the first alternating-current voltage V_{A}, second alternating-current voltage V_{B}, and third alternating-current voltage V_{C}. In the capacitive sensor 100, the first alternating-current voltage V_{A}, second alternating-current voltage V_{B}, and third alternating-current voltage V_{C} have the relation of V_{A}≥V_{B}>V_{C}. That is, the amplitude of the first alternating-current voltage V_{A} is larger than or equal to the amplitude of the second alternating-current voltage V_{B}, and the amplitude of the third alternating-current voltage V_{C} is smaller than the amplitude of the second alternating-current voltage V_{B}.

Here, as an example, the first alternating-current voltage V_{A}, second alternating-current voltage V_{B}, and third alternating-current voltage V_{C} have the relation of V_{A}>V_{B}>V_{C} as illustrated in FIG. 4 so that they are mutually different. The reason why they have the relation of V_{A}≥V_{B}>V_{C} will be described.

In equation (2), the capacitance Cf and capacitance Cs of the capacitances of individual portions change according to the degree of proximity and the degree of pressing. To detect a proximity, a contact, and pressing of the fingertip FT to the top panel 101 above the detection electrode 111 only from the output voltage V₀, it suffices for the output voltage V₀ to increase in the order of the proximity, contact, and pressing.

When a decision threshold value for proximity is denoted V1, a decision threshold value for a contact is denoted V2, and a decision threshold value for pressing is denoted V3, it will be assumed that they have the relation of V1<V2<V3. Then, it is only needed that a proximity is detected when the amplitude V₀ of the output voltage V₀ becomes larger than or equal to V1 and smaller than V2, a contact is detected when the amplitude V₀ of the output voltage V₀ becomes larger than or equal to V2 and smaller than V3, and pressing is detected when the amplitude V₀ of the output voltage V₀ becomes larger than or equal to V3. Thus, a proximity, a contact, and pressing of the fingertip FT to the top panel 101 can be detected according to the amplitude V₀ of the output voltage V₀.

Although an aspect will be described here in which the frequency of the first alternating-current voltage V_{A}, the frequency of the second alternating-current voltage V_{B}, and the frequency of the third alternating-current voltage V_{C} are equal to one another, it is only needed that the frequency of the first alternating-current voltage V_{A}, the frequency of the second alternating-current voltage V_{B}, and the frequency of the third alternating-current voltage V_{C} are substantially equal to one another. When the frequency of the first alternating-current voltage V_{A}, the frequency of the second alternating-current voltage V_{B}, and the frequency of the third alternating-current voltage V_{C} are substantially equal to one another, this indicates that the frequency of the first alternating-current voltage V_{A}, the frequency of the second alternating-current voltage V_{B}, and the frequency of the third alternating-current voltage V_{C} have only a small difference within a range in which no effect is caused on the detection, based on the output voltage V₀, of a proximity, a contact, and pressing of the fingertip FT to the top panel 101.

Here, the value of the term Cf×V_{B} in equation (2) increases as the fingertip FT comes closer to the top panel 101. To have the term (V_{B}−V_{C})×Cs in equation (2) increase as the top panel 101 is pressed by the fingertip FT, it suffices for the relation of second alternating-current voltage V_{B}>third alternating-current voltage V_{C} to hold. Thus, the relation of second alternating-current voltage V_{B}, >third alternating-current voltage V_{C} holds.

The effect of the parasitic capacitance between the detection electrode 111 and ground and capacitive couplings other than a capacitive coupling between the detection electrode 111 and the shield electrode 130 immediately below the detection electrode 111 are reduced by making the first alternating-current voltage V_{A} to be applied to the driving electrode 112 larger than the second alternating-current voltage V_{B}. When the effect of the parasitic capacitance between the detection electrode 111 and ground is small, the first alternating-current voltage V_{A} and second alternating-current voltage V_{B} may be equal to each other. Thus, it suffices for the relation of first alternating-current voltage V_{A}≥second alternating-current voltage V_{B} to hold.

By using the relation of first alternating-current voltage V_{A}≥second alternating-current voltage V_{B} like this, increases in the value of the term Cf×V_{B} in equation (2) and the value of the term (V_{B}−V_{C})×Cs in equation (2) can be stably reflected in the output voltage V₀ in the process in which a proximity, a contact, and pressing of the fingertip FT to the top panel 101 are performed. In this embodiment, the relation of first alternating-current voltage V_{A}>second alternating-current voltage V_{B} is satisfied, as an example.

As described above, the first alternating-current voltage V_{A}, second alternating-current voltage V_{B}, and third alternating-current voltage V_{C} only need to have the relation of V_{A}≥V_{B}>V_{C}. When the first alternating-current voltage V_{A}, second alternating-current voltage V_{B}, and third alternating-current voltage V_{C} having the relation like this are used, a proximity, a contact, and pressing of the fingertip FT to the top panel 101 can be detected by using the decision threshold value V1 for a proximity, the decision threshold value V2 for a contact, and the decision threshold value V3 for pressing, which have the relation of V1<V2<V3, according to the amplitude V₀ of the output voltage V₀.

Therefore, it is possible to provide the capacitive sensor 100 that can easily detect a proximity, a contact, and pressing of the fingertip FT (detection target) to the top panel 101. The capacitive sensor 100 switches among wires to connect the first voltage output unit 140A and two front-side electrodes 110 selected as the driving electrodes 112 together. In a state in which switching has been made among wire connections to connect the input terminal 151 and the front-side electrode 110 selected as the detection electrode 111 together, the capacitive sensor 100 can also detect a proximity, a contact, and pressing of the fingertip FT to the top panel 101 according to the output voltage V₀ at the output terminal 155 of the detection unit 150, without having to perform circuit switching and the like for the selected detection electrode 111 and selected driving electrodes 112.

Since only the output voltage V₀ is used as a single to detect a proximity, a contact, and pressing, wires for connecting a plurality of front-side electrodes 110, the first voltage output unit 140A, the second voltage output unit 140B, the third voltage output unit 140C, and the detection unit 150 together are minimized, so it is also possible to downsize the detection unit 150. Therefore, the capacitive sensor 100 having a simple structure can be provided.

Since only the output voltage V₀ is used as a single to detect a proximity, a contact, and pressing as described above, an increase in time required for processing to detect a proximity, a contact, and pressing can be suppressed to a minimum. Therefore, processing time taken for detecting a proximity, a contact, and pressing can be reduced.

As a driving unit to which to apply the first alternating-current voltage V_{A}, front-side electrodes 110 adjacent to the detection electrode 111 are preferably used as driving electrodes 112, the front-side electrodes 110 being included in a plurality of front-side electrodes 110, the front-side electrodes 110 being other than the detection electrode 111. Therefore, by using the capacitance Cp between the detection electrode 111 and each driving electrode 112, a proximity, a contact, and pressing of the fingertip FT to the top panel 101 can be detected according to the output voltage V₀. Since the capacitance Cp between the detection electrode 111 and each driving electrode 112 is used, a proximity, a contact, and pressing of the fingertip FT to the top panel 101 can be stably detected by using the capacitance Cp between adjacent front-side electrodes 110 according to output voltage V₀.

The detection unit 150 has the op-amp 152 having the inverting input terminal connected to the detection electrode 111 and the non-inverting input terminal to which the second alternating-current voltage V_{B} is applied, the op-amp 152 performing amplification operation. Due to a virtual short-circuit in the op-amp 152, the voltage at the inverting input terminal (−) becomes equal to a voltage to be applied to the non-inverting input terminal (+), so the second alternating-current voltage V_{B} is applied to the detection electrode 111. Therefore, the second alternating-current voltage V_{B} output by the second voltage output unit 140B can be applied to the front-side electrode 110 selected as the detection electrode 111.

Since the first alternating-current voltage V_{A}, second alternating-current voltage V_{B}, and third alternating-current voltage V_{C} are preferably sine waves, when the first voltage output unit 140A, second voltage output unit 140B, and third voltage output unit 140C are used, the output voltage V₀ can be easily obtained according to equation (2). In addition, a proximity, a contact, and pressing of the fingertip FT to the top panel 101 can be stably detected according the output voltage V₀ obtained in this way.

An aspect has been described above in which the first alternating-current voltage V_{A}, second alternating-current voltage V_{B}, and third alternating-current voltage V_{C} are sine waves. However, the first alternating-current voltage V_{A}, second alternating-current voltage V_{B}, and third alternating-current voltage V_{C} are sine waves may be square waves. Even when square waves are used instead of sine waves, a proximity, a contact, and pressing of the fingertip FT to the top panel 101 can be similarly detected according to the amplitude V₀ of the output voltage V₀. It suffices to use square wave generators instead of the first voltage output unit 140A, second voltage output unit 140B, and third voltage output unit 140C.

Of aspects in which the amplitude of the first alternating-current voltage V_{A} is larger than or equal to the amplitude of the second alternating-current voltage V_{B} and the amplitude of the third alternating-current voltage V_{C} is smaller than the amplitude of the second alternating-current voltage V_{B}, an aspect has been described above in which the relation of first alternating-current voltage V_{A}, >second alternating-current voltage V_{B}, >third alternating-current voltage V_{C} holds. However, the first alternating-current voltage V_{A}, second alternating-current voltage V_{B}, and third alternating-current voltage V_{C} may have the following relation, for example.

Even in a state in which the fingertip FT is not present, the capacitive sensor 100 outputs the output voltage V₀ according to capacitances generated between the detection electrode 111 and the driving electrode 112 and between the detection electrode 111 and a surrounding object. A state like this will be referred to as a non-manipulation state.

To easily detect a proximity of the fingertip FT when the fingertip FT begins to come close to the detection electrode 111 in the non-manipulation state, it suffices to increase the dynamic range of the capacitance Cf. When the first alternating-current voltage V_{A}, second alternating-current voltage V_{B}, and third alternating-current voltage V_{C} have a relation in which the term (V_{B}−V_{A})×Cp and term (V_{B}−V_{C})×Cs in equation (2) are mutually canceled in the non-manipulation state, the dynamic range of the capacitance Cf can be increased in equation (2).

Therefore, the amplitudes V_{A}, V_{B}, and V_{C} of the first alternating-current voltage V_{A}, second alternating-current voltage V_{B}, and third alternating-current voltage V_{C} may be set so that the term (V_{B}−V_{A})×Cp and term (V_{B}−V_{C})×Cs are mutually canceled in the non-manipulation state. It becomes easy to detect a proximity of the fingertip FT to the top panel 101 in the non-manipulation state.

Although an aspect has been described above in which a plurality of front-side electrodes 110 arranged in a matrix as illustrated in FIG. 1 are used. However, the plurality of front-side electrodes 110 included in the capacitive sensor 100 are not limited to this type of structure. For example, the plurality of front-side electrodes 110 may be structured so as to detect a proximity, a contact, and pressing of the fingertip FT to the top panel 101 according a change in capacitance between a plurality of electrodes that extend in the row direction (X direction) and are arranged in the Y direction and a plurality of electrodes that extend in the column direction (Y direction) and are arranged in the X direction. The plurality of electrodes that extend in the row direction (X direction) and are arranged in the Y direction and the plurality of electrodes that extend in the column direction (Y direction) and are arranged in the X direction may be electrodes patterned in a diamond shape in plan view.

### Embodiment 2

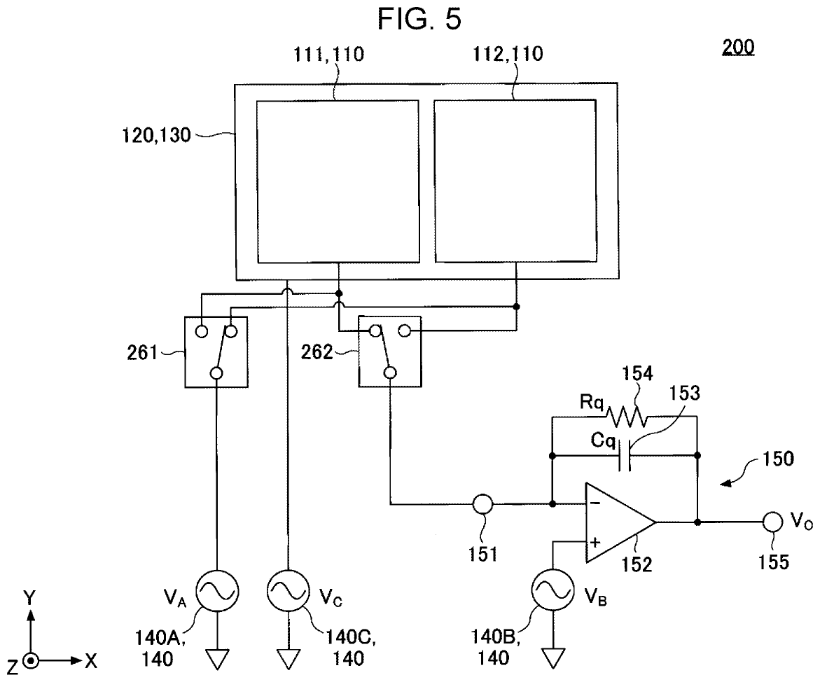

FIG. 5 illustrates a capacitive sensor 200 in embodiment 2. The capacitive sensor 200 includes the detection electrode 111, the driving electrode 112, the elastic dielectric body 120, the shield electrode 130, the first voltage output unit 140A, the second voltage output unit 140B, the third voltage output unit 140C, the detection unit 150, and selector switches 261 and 262. The selector switches 261 and 262 are each preferably an example of a selection unit that selects one or more detection electrodes 111 from the front-side electrodes 110. In FIG. 5, the structures of the detection electrode 111, driving electrode 112, elastic dielectric body 120, and shield electrode 130 are illustrated as being planar in an XY plane. In FIG. 5, the top panel 101 is omitted.

In embodiment 2, an aspect will be described in which the capacitive sensor 200 includes two front-side electrodes 110, one of which is used as the detection electrode 111 and the other of which is used as the driving electrode 112. Constituent elements similar to those of the capacitive sensor 100 in embodiment 1 will be given identical reference characters and descriptions of these constituent elements will be omitted.

The selector switches 261 and 262 are each a three-terminal switch. They can switch the connection destinations of the first voltage output unit 140A and input terminal 151 between the detection electrode 111 and the driving electrode 112. In FIG. 5, the front-side electrode 110 on the −X-direction side, which is used as the detection electrode 111, is connected to the input terminal 151 by the selector switch 262; and the front-side electrode 110 on the +X-direction side, which is used as the driving electrode 112, is connected to the first voltage output unit 140A by the selector switch 261. However, when the selector switches 261 and 262 are operated so that the front-side electrode 110 on the +X-direction side is connected to the input terminal 151 and the front-side electrode 110 on the −X-direction side is connected to the first voltage output unit 140A, the front-side electrode 110 on the −X-direction side can be used as the detection electrode 111 and the front-side electrode 110 on the +X-direction side can be used as the driving electrode 112.

When a capacitance (electrostatic capacity) between the detection electrode 111 and the driving electrodes 112 is denoted Cp, equation (2) holds as with the capacitive sensor 100 in embodiment 1. Therefore, when the first alternating-current voltage V_{A}, second alternating-current voltage V_{B}, and third alternating-current voltage V_{C} have the relation of V_{A}≥V_{B}>V_{C}, a proximity, a contact, and pressing of the fingertip FT to the detection electrode 111 can be detected according to the output voltage V₀ from the output terminal 155 of the detection unit 150, as with the capacitive sensor 100 in embodiment 1.

Even when the front-side electrode 110 on the −X-direction side is used as the detection electrode 111 and the front-side electrode 110 on the +X-direction side is used as the driving electrode 112, a proximity, a contact, and pressing of the fingertip FT to the detection electrode 111 can be similarly detected according to the output voltage V₀ from the output terminal 155 of the detection unit 150.

Thus, when one of the two front-side electrodes 110 is used as the detection electrode 111 and the other is used as the driving electrode 112, a proximity, a contact, and pressing of the fingertip FT to the detection electrode 111 can be detected.

Therefore, it is possible to provide the capacitive sensor 200 that can easily detect a proximity, a contact, and pressing of the fingertip FT (detection target) to the top panel 101. The selector switches 261 and 262 included in the capacitive sensor 200 as selection units selectively select the detection electrode 111 from front-side electrodes 110. The second voltage output unit 140B outputs the second alternating-current voltage V_{B} to the detection electrode 111 selected by the selector switch 261 or 262, whichever is appropriate. Therefore, when the selector switches 261 and 262 are added as a minimal circuit to selectively set each of the two front-side electrodes 110 to the detection electrode 111 or driving electrode 112, a proximity, a contact, and pressing of the fingertip FT (detection target) to the top panel 101 can be detected according to the output voltage V₀.

An aspect has been described in embodiment 2 in which one of the two front-side electrodes 110 is used as the detection electrode 111 and the other is used as the driving electrode 112. However, when, for example, the capacitive sensor 200 includes three front-side electrodes 110 arranged in the X direction, a proximity, a contact, and pressing of the fingertip FT to the detection electrode 111 can be detected by connecting three selector switches similar to the selector switches 261 and 262 to the three front-side electrodes 110 as follows. When the front-side electrode 110 on the −X-direction side is selected as the detection electrode 111, the front-side electrode 110 at the center in the X direction and the front-side electrode 110 on the +X-direction side are selected as the driving electrodes 112. When the front-side electrode 110 on the +X-direction side is selected as the detection electrode 111, the reverse is applicable.

When the front-side electrode 110 at the center in the X direction is used as the detection electrode 111, the front-side electrodes 110 on the −X-direction side and on the +X-direction side are used as the driving electrodes 112 to detect a proximity, a contact, and pressing of the fingertip FT to the detection electrode 111. It is also possible to use one of the front-side electrodes 110 other than the detection electrode 111 as the driving electrode 112 and to use the remaining front-side electrodes 110 as floating electrodes.

When four or more front-side electrodes 110 are use, a plurality of capacitive sensors 200 illustrated in FIG. 5 only need to be provided to detect a proximity, a contact, and pressing to the front-side electrode 110 selected as the detection electrode 111.

### Embodiment 3

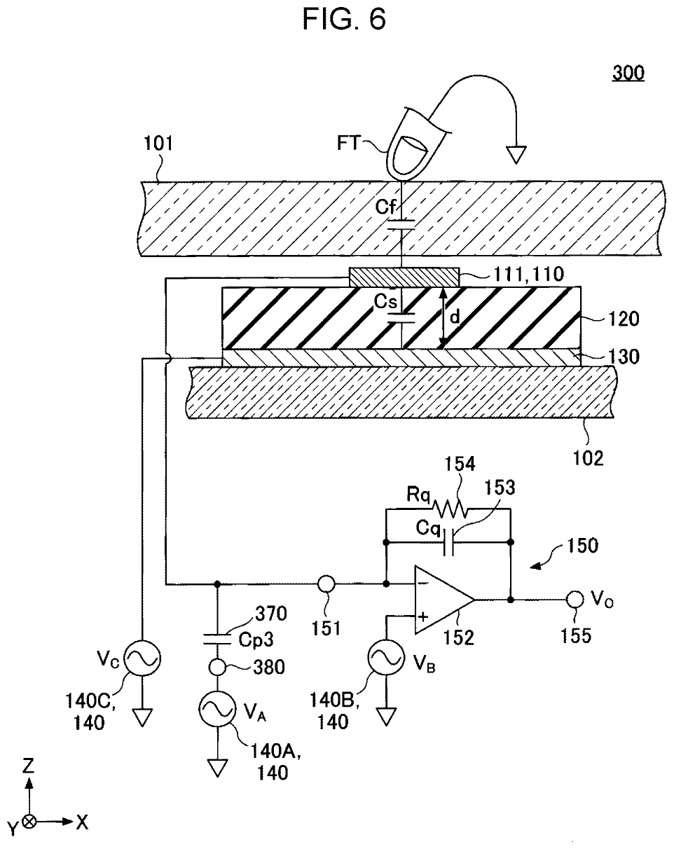

FIG. 6 illustrates a capacitive sensor 300 in embodiment 3. The capacitive sensor 300 includes the top panel 101, the substrate 102, the detection electrode 111, the elastic dielectric body 120, the shield electrode 130, the first voltage output unit 140A, the second voltage output unit 140B, the third voltage output unit 140C, the detection unit 150, a capacitor 370, and a terminal 380.

In embodiment 3, an aspect will be described in which the capacitive sensor 300 includes only one front-side electrode 110, which is used as the detection electrode 111. Constituent elements similar to those of the capacitive sensor 100 in embodiment 1 will be given identical reference characters and descriptions of these constituent elements will be omitted.

The capacitor 370 is disposed instead of forming the capacitance Cp between the detection electrode 111 and the two driving electrodes 112 in embodiment 1. The capacitor 370 has a capacitance Cp3. The capacitance Cp3 is equal to the capacitance Cp in embodiment 1, as an example.

The terminal 380 is an example of the driving unit. The terminal 380 is connected with the capacitance Cp3 intervening between the terminal 380 and the detection electrode 111. The terminal 380 in this embodiment is a constituent element to which the first alternating-current voltage V_{A} is output from the first voltage output unit 140A, instead of to the two driving electrodes 112 in embodiment 1.

The capacitance Cf between the detection electrode 111 and the fingertip FT and the capacitance Cs between the detection electrode 111 and the shield electrode 130 are respectively similar to the capacitance Cf and capacitance Cs in embodiment 1. Therefore, as in embodiment 1, the output voltage V₀ from the output terminal 155 of the detection unit 150 can be represented as in equation (2).

Therefore, the capacitive sensor 300 in embodiment 3 can detect a proximity, a contact, and pressing of the fingertip FT to the detection electrode 111, as with the capacitive sensor 100 in embodiment 1.

Therefore, it is possible to provide the capacitive sensor 300 that can easily detect a proximity, a contact, and pressing of the fingertip FT (detection target) to the top panel 101.

In embodiment 3, the capacitive sensor 300, in which only one front-side electrode 110, which is employed as the detection electrode 111, is used, has been described. When a plurality of front-side electrodes 110 are used, a plurality of capacitive sensors 300 illustrated in FIG. 6 only need to be provided so that each front-side electrode 110 is used as the detection electrode 111 to detect a proximity, a contact, and pressing to each detection electrode 111.

This completes the description of the capacitive sensor in an exemplary embodiment in the present invention. However, the present invention is not limited to specifically disclosed embodiments, but can be varied and modified in various other ways without departing from the scope of the claims.

This international application claims priority based on Japanese Patent Application No. 2021-048247 filed on Mar. 23, 2021, and the entire contents of the application are incorporated in this international application by reference in it.

What is claimed is:

1. A capacitive sensor comprising:
one or a plurality of front-side electrodes including one or more detection electrodes;
an elastic dielectric body disposed below the one or plurality of front-side electrodes;
a shield electrode disposed with the elastic dielectric body interposed between the shield electrode and the one or plurality of front-side electrodes;
a driving unit coupled to the one or more detection electrodes with a capacitance intervening between the driving unit and the one or more detection electrodes;
a first voltage output unit that outputs a first alternating-current voltage to the driving unit;
a second voltage output unit that outputs a second alternating-current voltage having a frequency substantially equal to a frequency of the first alternating-current voltage, the second alternating-current voltage being applied to the one or more detection electrodes;
a third voltage output unit that outputs a third alternating-current voltage to the shield electrode, the third alternating-current voltage having a frequency substantially equal to the frequency of the first alternating-current voltage and to the frequency of the second alternating-current voltage; and
a detection unit that detects a proximity, a contact, and pressing of a detection target to the one or more detection electrodes; wherein
the first voltage output unit, the second voltage output unit, and the third voltage output unit respectively output the first alternating-current voltage, the second alternating-current voltage, and the third alternating-current voltage so that an amplitude of the first alternating-current voltage becomes larger than or equal to an amplitude of the second alternating-current voltage and that an amplitude of the third alternating-current voltage becomes smaller than the amplitude of the second alternating-current voltage.

2. The capacitive sensor according to claim 1, wherein:
the one or plurality of front-side electrodes are a plurality of front-side electrodes; and
the driving unit is at least one front-side electrode included in the plurality of front-side electrodes, the at least one front-side electrode being other than the one or more detection electrodes.

3. The capacitive sensor according to claim 1, further comprising a selection unit that selects the one or more detection electrodes from the one or plurality of front-side electrodes, wherein
the second voltage output unit outputs the second alternating-current voltage to the one or more detection electrodes selected by the selection unit.

4. The capacitive sensor according to claim 1, wherein the detection unit has an operational amplifier circuit that has an inverting input terminal connected to the one or more detection electrodes and also has a non-inverting input terminal to which the second alternating-current voltage is applied.

5. The capacitive sensor according to claim 4, wherein when a capacitance between the detection electrode and the detection target is denoted Cf, a capacitance between the detection electrode and the driving unit is denoted Cp, a capacitance between the detection electrode and the shield electrode is denoted Cs, the first alternating-current voltage is denoted V_{A}, the second alternating-current voltage is denoted V_{B}, the third alternating-current voltage is denoted V_{C}, a capacitance of a capacitor connected between an output terminal of the operational amplifier circuit and the non-inverting input terminal is denoted Cq, and an output voltage at the output terminal is denoted V₀, the output voltage V₀ is represented as in equation (1) below.
$${V}_{0} = \frac{{C}_{f} \times {V}_{B} + ( {V}_{B} - {V}_{A} ) \times {C}_{p} + ( {V}_{B} - {V}_{C} ) \times {C}_{s}}{{C}_{q}} \qquad ( 1 )$$

6. The capacitive sensor according to claim 5, wherein the amplitude of the first alternating-current voltage, the amplitude of the second alternating-current voltage, and the amplitude of the third alternating-current voltage are set to such amplitudes V_{A}, V_{B}, and V_{C} that a term (V_{B}−V_{A})×Cp and a term (V_{B}−V_{C})×Cs in the equation (1) are mutually canceled in a state in which the proximity, the contact, and the pressing by the detection target is not being performed.

7. The capacitive sensor according to claim 1, wherein the first alternating-current voltage, the second alternating-current voltage, and the third alternating-current voltage are each a sine wave.

8. The capacitive sensor according to claim 1, wherein the first alternating-current voltage, the second alternating-current voltage, and the third alternating-current voltage are each a square wave.
